(19) United States
(12) Patent Application Publication
(10) Pub. No.: US 2005/0051083 A1
(43) Pub. Date: Mar. 10, 2005

(54) Apparatus for carrying reticles and method of using the same to process reticles

(76) Inventors: Carlos Ruiz, Schnecksville, PA (US); Ismall Kashkoush, Orefield, PA (US)

Correspondence Address: COZEN O'CONNOR, P.C., 1900 MARKET STREET, PHILADELPHIA, PA, 19103-3508, US

(21) Appl. No.: 10/931,441

(22) Filed: Sep. 1, 2004

Related U.S. Application Data
(60) Provisional application No. 60/500,856, filed on Sep. 5, 2003.

(51) Int. Cl. B05C 11/00; B05C 13/00

(52) U.S. Cl. 118/58; 118/68

(57) ABSTRACT

An apparatus for carrying reticles during a multi-step, multi-location treatment process comprising a structural frame carrying at least three holding rods, the rods and/or frame being constructed of a hard inner core material and a chemically resistant outer material is disclosed. The apparatus, in one embodiment, further comprises a plurality of slots for supporting the reticles that minimize the contact area between the reticles and the apparatus. Suitable hard inner core materials include carbon fiber, quartz, ceramic, PEEK, and silicon carbide. Suitable outer material includes fluoropolymers, such PTFE, PFA, TFM, and ECTFE. The apparatus is preferably adapted to withstand a reticle treatment process temperature between 20-180° C. The rods and frame are preferably designed to minimize shadowing effects of reticles supported in the apparatus being exposed to megasonic energy. In another aspect, the invention is a method of processing reticles using the inventive apparatus.

### CROSS-REFERENCE TO RELATED APPLICATIONS

The present application claims the benefit of U.S. Provisional Application 60/500,856, filed Sep. 5, 2003, which is hereby incorporated by reference in its entirety.

### FIELD OF THE INVENTION

The invention relates generally to the field of reticle processing, and specifically to apparatus used to carry said reticles and methods of using the same.

### BACKGROUND OF THE INVENTION

Reticles must be carried during multi-step chemical treatment processes and must be reliably transferred between different treatment locations in such processes. While reticle carriers exist that have been used to support reticles during processing, they all suffer from one or more disadvantages. For example, some reticle carriers have high chemical drag from a process tank to a rinse tank, thereby increasing the chemical and water consumption. Other reticle carriers do not have good flow dynamics or exhibit large shadowing of sonic energy which is often employed in reticle treatment processes. Some reticle carriers have large reticle contact areas which increases the risk of contamination and can trap chemicals.

Additionally, reticle carriers can be subjected to high temperatures during reticle processing. Existing reticle carriers can experience unwanted deformation and/or creep. Moreover, because of the materials of which some reticle carriers are constructed, the reticle carriers can either contaminate the reticles and/or can not withstand high processing temperatures.

### SUMMARY OF THE INVENTION

It is therefore, an object of the present invention to provide a reticle carrier that is both durable and resistant to chemicals.

Another object of the present invention to provide a reticle carrier that optimizes load carrying capacity while minimizing the fluid flow obstruction during processing.

Still another object of the present invention to provide a reticle carrier that enhances the drying cycle of reticles.

Yet another object of the present invention to provide a reticle carrier that affords reliable transfer of reticles at high robot speeds.

A further object of the present invention to provide a reticle carrier that reduces reticle contact area to reduce the trapping of contaminates and/or process fluids.

A yet further object of the present invention to provide a reticle carrier that minimizes thermal expansion.

A still further object of the present invention to provide a reticle carrier that reduces chemical drag from one tank to another.

It is also an object of the present invention to provide a reticle carrier that reduces process and rinse cycle times.

Still another object of the present invention to provide a reticle carrier that minimizes sonic energy shadowing and/or that provides for complete sonic energy coverage of reticles positioned therein.

A further object of the present invention to provide a reticle carrier that provides support rods that are removable for easy replacement.

These and other objects are met by the present invention which, in one aspect is an apparatus for carrying reticles comprising: a structural frame carrying at least three holding rods; the rods constructed of a hard inner core material and a chemically resistant outer material.

The frame preferably comprises a substantially flat front panel, a substantially flat back panel opposing the front panel, and two substantially flat side panels connecting the front and back panels. In this embodiment, the front panel, the back panel, and the two side panels are preferably oriented substantially vertical so as to minimize fluid flow obstruction. The top surface of each of the two side panels can be curved or angled to minimize chemical drag.

Similar to the rods, the frame can also be constructed of a hard inner core material and a chemically resistant outer material. The hard inner core material of the frame and the rods can be selected from a variety of materials, such as quartz, ceramic, PEEK, and silicon carbide. The outer material of the frame and the rods can be a fluoropolymer, such as PTFE, PFA, and ECTFE. The apparatus is preferably adapted to withstand a reticle treatment process temperature between 20-180° C.

It is preferred that each rod have a plurality of slots for receiving and supporting reticles in a substantially vertical position. In this embodiment, the rods are oriented in the frame so that the slots on the rods are aligned. The rods can be generally circular or elliptical in cross-section and the slots preferably extend around the entire perimeter of the rods, forming a groove.

In order to minimize contact are between reticles and the apparatus, the slots can be provided with angled walls that contact and support edges of a reticle positioned therein. It is further preferable that the rods comprise at least one bottom holding rod and at least one side holding rod. Most preferably, two bottom holding rods and two side holding rods are supplied. In this embodiment, the slots on the side holding rods will have a ridge located at the bottom of the slots so that when a reticle is loaded therein, the reticle will contact only the angled walls and the ridge. The slots on the bottom holding rod also have angled walls so that when a reticle is position therein, the reticle only contacts the angled walls.

The apparatus is preferably adapted to support a load of 1 to about 10 reticles. The side holding rods are preferably generally circular in cross-section as well as the bottom holding rods. The bottom holding rods are adapted to carry more weight than the side holding rods. The side holding rods are located in a position to guide carried reticles so as to prevent the carried reticles from leaning against each other.

The apparatus also can comprise means for a robotic device to pick the apparatus up at three points, wherein the points are arranged so the apparatus is stable and can be transferred at high robotic speeds. All of the rods preferably comprise a means for locking and unlocking the rods to the frame, and thus, are removable from the frame.

The rods and the frame are preferably designed to minimize shadowing effects on reticles supported in the apparatus and being exposed to megasonic energy. The frame can also comprise means to facilitate proper alignment of the apparatus in a process tank. Finally, the two bottom holding rods can be connected to the frame so that one of the rods is at a lower position than the other rod so that when a reticle is loaded into the apparatus, a top edge of the reticle is at an incline (from side to side).

In another aspect, the invention is a method of processing reticles comprising: providing an apparatus comprising a structural frame carrying at least three holding rods, the rods constructed of a hard inner core material and a chemically resistant outer material; loading at least one reticle into the apparatus; positioning the apparatus and loaded reticles in a process chamber; and performing a first reticle treatment process to the loaded reticles. The method can further comprise performing a second reticle treatment process to the loaded reticles without removing the reticles from the apparatus.

### BRIEF DESCRIPTION OF THE DRAWINGS

FIG. 1 is a front perspective view of a reticle carrier according to an embodiment of the invention having a reticle loaded therein.

FIG. 2 is a back perspective view of the reticle carrier and loaded reticle of FIG. 1.

FIG. 3 is a perspective view of a bottom holding rod of the reticle carrier of FIG. 1 removed therefrom.

FIG. 4 is perspective view of a side holding rod of the reticle carrier of FIG. 1 removed therefrom.

FIG. 5 is a front perspective view of a frame of the reticle carrier of FIG. 1 with all of the holding rods removed therefrom.

FIG. 6 is a back perspective view of the frame of the reticle carrier of FIG. 1 with all of the holding rods removed therefrom.

FIG. 7 is a top view of a section of the bottom holding rod of FIG. 3 illustrating its slot design detail.

FIG. 8 is a top view of a section of the side holding rod of FIG. 4 illustrating its slot design detail.

### DETAILED DESCRIPTION OF THE DRAWINGS

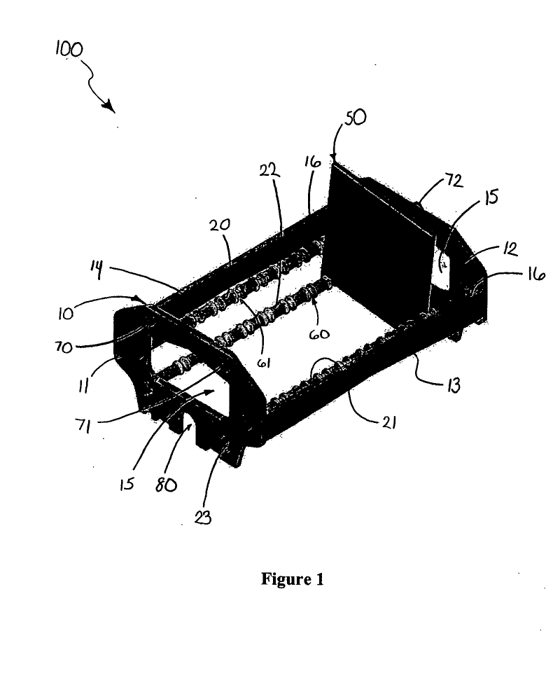

Referring to FIG. 1, reticle carrier 100 is illustrated according to one embodiment of the invention with a reticle 50 loaded therein. Reticle carrier 100 comprises frame 10 and holding rods 20-23. Frame 10 comprises front panel 11, back panel 12, and side panels 13,14. Side panels 13, 14 are secured to and connect front and back panels 10, 11 to form a rigid structure (i.e., frame 10). Panels 11-14 are substantially flat. Frame 10 is constructed so that when the reticle carrier 50 is in an upright position, all of the panels 11-14 are in a substantially vertical orientation. By orienting the panels 11-14 substantially vertical, the frame 10 minimizes the obstruction of fluid flow when reticle carrier 100 is used to support the reticles 50 during processing in a process chamber, thereby affording superior process fluid flow.

Moreover, frame 10 is designed so that its mass and surface area is minimized, thus reducing the chemical drag between process tanks and to a rinse tank. Reducing chemical drag from tank to tank, in turn, reduces chemical consumption, enhances rinsing of the reticles 50, conserves water consumption, and significantly reduces cross contamination between tanks, thereby reducing the process and rinse cycle times. Openings 15 are provided in front and back panels 11 and 12 to further contribute to the achievement of these goals.

Additionally, the top surface 16 of side panels 13 and 14 are created so as to be curved. Specifically, the top edge surfaces 16 have cross-sectional profiles that are semi-circular. By not making the top surfaces 16 of side panels 13 and 14 a substantially horizontal flat surface, the amount of fluids that get trapped on these surfaces during removal from chemical baths is further decreased. While the top surfaces 16 are illustrated as being curved, it is possible to achieve this goal by shaping a variety of shapes, such as an apex, a single angle, or other non-concave and/or horizontally flat surfaces. Moreover, any and/or all of the top surfaces present on the frame 10 can be so shaped, including specifically all of the top surfaces of front and back panels 11 and 12.

Rods 20-23 and frame 10 of reticle carrier 100 are constructed of a “hard” inner core material surrounded by a chemically resistant outer material. Suitable “hard” inner core material include carbon fiber, quartz, ceramic, PEEK or silicon carbide. The chemically resistant outer material is preferably a coating of fluoropolymer material, such as for example PTFE, PFA, TFM or ECTFE. However, those skilled in the art will appreciate that other materials can be used. By constructing reticle carrier 100 as such, a metal-free, high temperature apparatus is formed that will withstand thermal cycling with no significant creep deformation. The holding rods 20-23 can support a load of typically 1 to 10 reticles at a process temperature up to 180° C. without experiencing deformation or substantial creep.

Reticle carrier 100 comprises four holding rods 20-23. However, the invention is not so limited and can be constructed with as many holding rods as is needed, so long as a minimum of three rods are used. Holding rods 20-23 are positioned accordingly to support the applied load from the reticles.

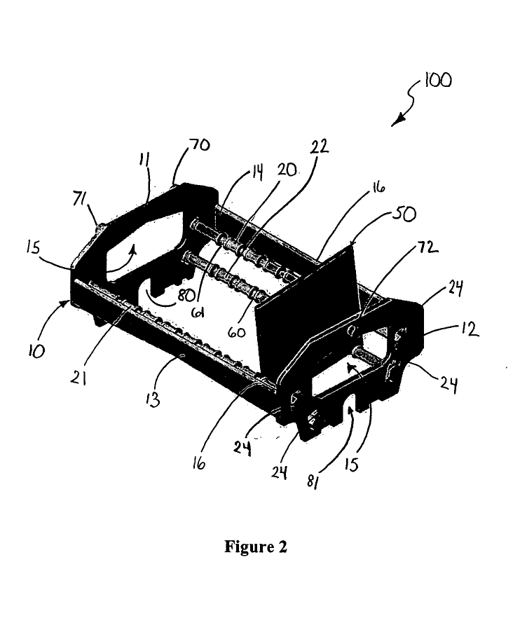

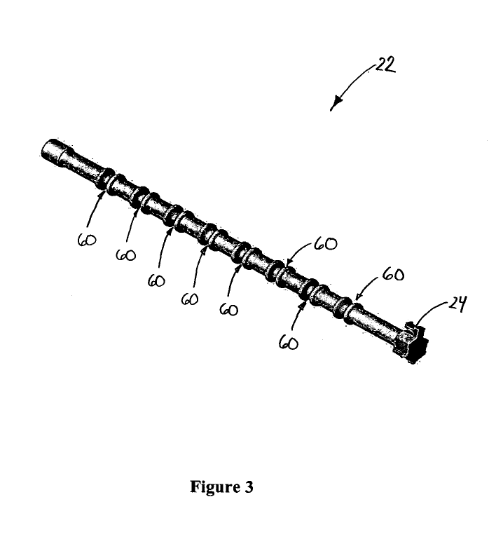

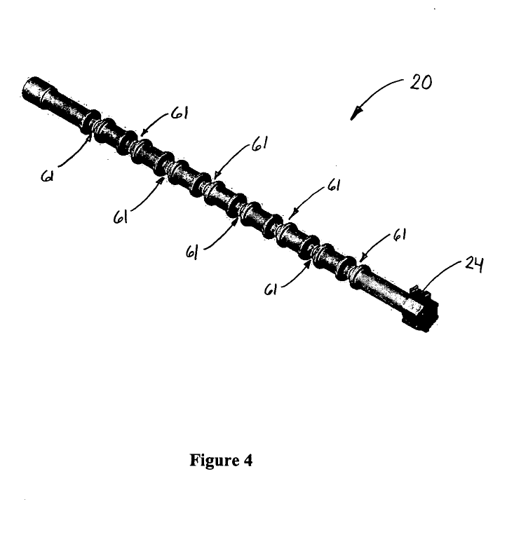

Referring now to FIG. 2-4, each of holding rods 20-23 have a clip 24 (best shown in FIGS. 3 and 4) located at their trailing ends. Clip 24 is provided to afford easy removal of the holding rods 20-23 from frame 10 for replacement if necessary. Clip 24 is of the compression type comprising a barb 25 for engagement and locking. Clip 24 engages a wall by being compressed as it passes though a hole. Once barb 25 passes through the hole, clip 24 expands, causing the barb 25 to engage the opposite side of the wall. While a clip is illustrated as being the means for locking and unlocking holding rods 20-23 from frame 10, any other locking means can be used, such as for example a cotter pin, a tight-fit assembly, a threaded nut-bolt like connection, or a snap-fit assembly.

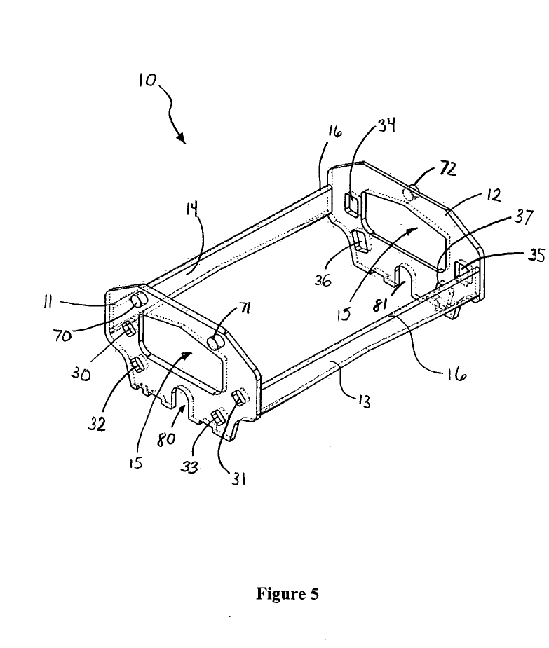

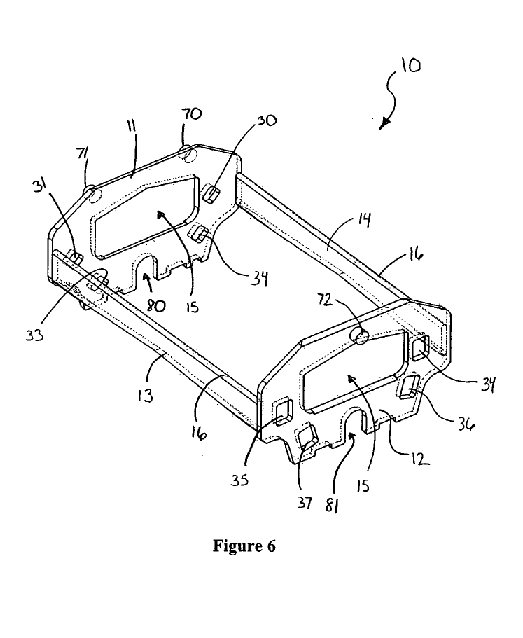

In FIGS. 5 and 6, frame 10 is illustrated with holding rods 20-23 removed. When removed, front panel 10 has four holes 30-33 for receiving the front end of holding rods 20-23. Back panel 11 has four holes 34-37 for receiving the back end of holding rods 20-23 which are aligned with the four holes 30-33 of front panel 10. In assembling reticle carrier 100, the lead end of each of holding rods 20-23 are respectively inserted through holes 34-37 until the lead ends enter into holes 30-33. At this point, the trailing end of holding rods 20-23 begin to penetrate holes 34-37 of back panel 12, causing clip 24 (FIGS. 3 and 4) to enter holes 34-37 and lock holding rods 20-23 in place as discussed above.

The structural component of reticle carrier 100 is provided by frame 10, which is designed to provide rigidity to reticle carrier 100. The hard inner core material of frame 10 is preferably constructed of quartz to provide the highest possible purity. However, other materials can be selected to provide strength and purity. Also, other shapes could be considered as long as the strength and the fluid flow dynamics are not compromised. All surfaces of frame 10 are over-coated with a high purity fluoropolymer.

Referring back to FIG. 1, holding rods 20-23 consist of two side holding rods and two bottom holding rods. More specifically, holding rods 20 and 21 are side holding rods while holding rods 22 and 23 are bottom holding rods. When reticles 50 are loaded into reticle carrier 100, bottom holding rods 22, 23 are under the highest load and are designed to optimize load carrying capacity while minimizing fluid flow obstruction and enhancing the drying cycle of the reticles 50. The side holding rods 20, 21 are located so that the reticles 50 are guided during loading and prevent the reticles 50 form leaning against each other. Reticles 50 are supported in a substantially vertical orientation when loaded.

However, in order to avoid water or other chemicals from getting trapped on the top edge/surface of the reticles 50, bottom holding rod 23 is located in frame 10 at a lower position than is bottom holding 22. Thus, when reticles 50 are loaded and supported in reticle carrier 100, the reticles 50 are slightly tilted, allowing water and other chemicals to easily slide off.

The holding rods 20-23 are designed to support a load of typically 1 to 10 reticles 50 (6″×6″×0.25″ in size) at a process temperature up to 180° C. Side holding rods 20, 21 have a generally circular cross-section. However, because most of the load will be resting on bottom holding rods 22, 23, bottom holding rods will be designed so as to have a greater load bearing capacity. For example, the hard inner core material can be made thicker. Alternatively, bottom holding rods 22, 23 can be designed to have an elliptical cross-section having a major and a minor axis. In order to optimize load carrying capacity in this embodiment while minimizing fluid flow obstruction, the major axis of the elliptical cross-section is aligned in the load bearing direction, which in the illustrated case would be vertically for bottom holding rods 22, 23. The maximum initial deflection at room temperature through 180° C. for bottom holding rods 22, 23 is designed to be less than 0.007 inches in the direction of the load.

Regarding the detail of the holding rods 20-23, bottom holding rods 22, 23 comprise a plurality of support slots 60 for receiving and supporting loaded reticles 50. Similarly, side holding rods 20, 21 comprises a plurality of guide slots 61 for guiding and supporting loaded reticles 50. Support slots 60 and guide slots 61 are positioned on bottom holding rods 22, 23 and side holding rods 20, 21 respectively so that the slots 60, 61 are aligned so that they can support a plurality of reticles 50 in a substantially vertical orientation.

The geometries of slots 60, 61 are designed to provide minimum and soft contact (1-3 mm depth) with reticles 50 and will be molded into the fluoropolymer over-molding (i.e. the chemically resistant outer material). While the geometries of support slots 60 are different from guide slots 61, as will be discussed in detail below, both geometries are designed for minimal (line) reticle contact area and are free of pockets that can trap contaminates and/or process fluids. Both geometries also provide optimum liquid drying at the contact areas and allow the reticles 50 to be held only at their edges, thus minimizing the edge exclusion to an absolute minimum. This is a desired feature during reticle manufacturing or servicing as part of the IC (integrated circuits) manufacturing.

When loaded into reticle carrier 100, each reticle 50 is supported with only two points of contact, one at each of the bottom holding rods 22, 23. In addition, each reticle 50 is held by the two side holding rods 20, 21 for stability and to prevent the reticles 50 from moving and touching each other.

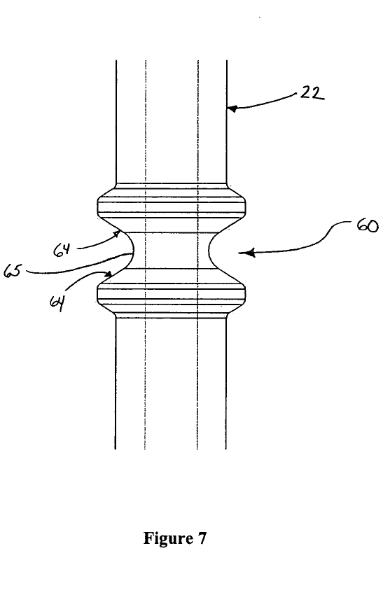

Referring to FIG. 3, it can be seen that a plurality of support slots 60 are provided on bottom holding rods 22, 23 (only rod 22 is illustrated for exemplary purposes with the understanding that rod 23 is identical). While a total of eight support slots are provided on bottom holding rods 22, 23, the invention is not limited to any specific number of slots. The hard inner core of bottom holding rods 22, 23 has a circular cross-sectional profile. However, the fluoropolymer over-molding is applied so that the resultant cross-sectional profile of bottom holding rods 22, 23 is generally circular as described in detail above. Support slots 60 are formed into the fluoropolymer over-molding and extend around the entire outer perimeter of the bottom holding rods 22, 23 so as to form a continuous trench. The geometry of support slots 60 is shown in greater detail in FIG. 7.

Referring now to FIG. 7, the geometry of one of support slots 60 of bottom holding rods 22, 23 is illustrated. Support slot 60 is a generally V-shaped groove with a rounded bottom. Support slot 60 comprises angles walls 63 that terminate in a rounded apex 64. Support slot 60 is preferably 1-3 mm deep, but can be designed to be any depth needed. The angle of the walls 64 and the width of the support slot 60 are such that when a reticle 50 is positioned therein, the reticle edge only contacts the angles walls 64, thereby minimizing contact are between the reticles 50 and the reticle carrier 100.

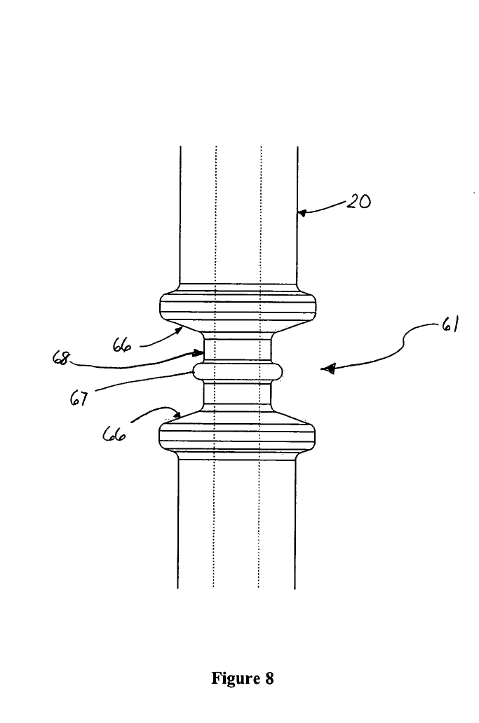

Referring now to FIG. 4, it can be seen that a plurality of guide slots 61 are provided on side holding rods 20, 21 (only rod 20 is illustrated for exemplary purposes with the understanding that rod 21 is identical). While a total of eight guide slots 61 are provided on side holding rods 20, 21, the invention is not limited to any specific number of slots. The hard inner core of side holding rods 20,21 has a circular cross-sectional profile and the fluoropolymer over-molding is applied so that the resultant cross-sectional profile of side holding rods 20, 21 is also circular. Guide slots 61 are formed into the fluoropolymer over-molding and extend around the entire outer perimeter of the side holding rods 20, 21 so as to form a continuous trench. The geometry of guide slots 61 is shown in greater detail in FIG. 8.

Referring to FIG. 8, the geometry of one of guide slots 61 of side holding rods 20,21 is illustrated. Guide slot 61 comprises angled walls 66 which terminate in bottom surface 68. Rounded ridge 68 is provided on bottom surface 67. Support slot 61 is preferably 1-3 mm deep, but can be designed to be any depth needed. When a reticle 50 is positioned therein, the reticle edge only contacts the angles walls 66 and/or rounded ridge 68, thereby minimizing contact are between the reticles 50 and the reticle carrier 100.

Referring back to FIGS. 1 and 2, frame 10 includes three knobs 70-72 for facilitating 3-point pick up of reticle carrier 100 for stable and reliable transfer at the highest robot speeds. Knobs 70 and 71 are symmetrically located on front panel 11. Knob 73 is located in the middle of back panel 12.

Additionally, semi-circular opening 80, 81 are provided in front panel 11 and back panel 12 of frame 10 respectively. Opening 80, 81 provide a means by which the positioning of reticle carrier 100 can be ensured within a process tank. For example, the process tank can comprise a tube on it bottom that mates with openings 80, 81, thereby ensuring proper processing alignment.

As mentioned above all of the surfaces of the hard inner core material of reticle carrier 100 are over-coated with a high purity fluoropolymer. This combines chemical resistance and purity of the most advanced high performance fluoropolymers with the structural integrity and thermal performance of high temperature polymer composites. Moreover, thermal expansion of reticle carrier 100 is held to an absolute minimum.

Reticle carrier 100 provides a number of advantages over prior art carriers. Holding rods 20-23 are designed with low profile design for minimal reticle contact area and superior process fluid flow are used. Specifically, the design of bottom holding rods 22, 23 provide for optional stiffness with minimal flow restrictions. The open space between the frame 10 and rods 20-23 result in better flow dynamics, which yields better process results. The open space between the frame 10 and rods 20-23 allows for complete sonic energy coverage on the reticles 50. Moreover, the minimized cross-sectional area of the rods 20-23 eliminates any shadowing of the sonic energy. Finally, minimum contact between the rods 20-23 and the reticles 50 reduces or eliminates potential for cross-contamination of tanks by reducing the amount of chemicals or residues retained at the slots 60, 61.

Finally, reticle carrier 100 facilitates consecutive processing of a plurality of reticles 50 in different chemicals and/or rinse fluids without the reticles 50 having to be removed from the carrier 100 because chemical drag is minimized. When processing reticles according to this method, the reticles 50 will be loaded into reticle carrier 100 as illustrated in FIG. 1, the carrier 100 and the loaded reticle 50 will then be placed in a process chamber and subjected to a processing fluid, such as a chemical or rinse water. Subsequently, the carrier 100 and reticles 50 will be subjected to another processing fluid, in the same or another process chamber without removing the reticles 50 from the carrier 100.

While the invention has been described and illustrated in detail herein, various modifications, improvements, and alternative embodiments should become readily apparent to those skilled in this art without departing from the spirit and scope of the invention.

1. An apparatus for carrying reticles comprising:
a structural frame carrying at least three holding rods;
the rods constructed of a hard inner core material and a chemically resistant outer material.

2. The apparatus of claim 1 wherein the frame comprises a substantially flat front panel, a substantially flat back panel opposing the front panel, and two substantially flat side panels connecting the front and back panels.

3. The apparatus of claim 2 wherein the front panel, the back panel, and the two side panels are oriented substantially vertically.

4 The apparatus of claim 2 wherein a top surface of each of the two side panels is curved or angled.

5. The apparatus of claim 1 wherein the frame is constructed of a hard inner core material and a chemically resistant outer material.

6. The apparatus of claim 5 wherein the hard inner core material of the frame is selected from the group consisting of carbon fiber, quartz, ceramic, PEEK, and silicon carbide.

7. The apparatus of claim 5 wherein the outer material is a fluoropolymer.

8. The apparatus of claim 1 wherein the hard inner core material of the rods is selected from the group consisting of quartz, ceramic, PEEK, and silicon carbide.

9. The apparatus of claim 1 wherein the outer material of the rods is a fluoropolymer.

10. The apparatus of claim 9 wherein the fluoropolymer is selected from the group consisting of PTFE, TFM, PFA, and ECTFE.

11. The apparatus of claim 1 wherein the apparatus is adapted to withstand a reticle treatment process temperature between 20-180° C.

12. The apparatus of claim 1 wherein each rod has a plurality of slots for receiving and supporting reticles in a substantially vertical position, the rods oriented in the frame so that the slots on the rods are aligned.

13. The apparatus of claim 12 wherein the rods are generally circular or elliptical in cross-section, the slots extending around a perimeter of the rods.

14. The apparatus of claim 12 the slots have angled walls that contact and support edges of a reticle positioned therein.

15. The apparatus of claim 14 wherein the rods comprise at least one bottom holding rod and at least one side holding rod, the slots on the side holding rods having a ridge located at a bottom of the slots so that when a reticle is position therein, the reticle contacts only the angled walls and the ridge.

16. The apparatus of claim 14 wherein the rods comprise at least one bottom holding rod and at least one side holding rod, the angled walls on the slots of the bottom holding being angled so that when a reticle is position therein, the reticle contacts only the angled walls.

17. The apparatus of claim 1 the apparatus is adapted to support a load of 1 to about 10 reticles.

18. The apparatus of claim 1 wherein the rods comprise at least one bottom holding rod and at least one side holding rod, the side holding rods and the bottom holding rods being generally circular in cross-section.

19. The apparatus of claim 1 wherein the rods comprise at least one bottom holding rod and at least one side holding rod, the bottom holding rods adapted to carry more weight than the side holding rods.

20. The apparatus of claim 19 wherein the side holding rods are located in a position to guide carried reticles so as to prevent the carried reticles from leaning against each other.

21. The apparatus of claim 1 having means for a robotic device to pick the apparatus up at three points on the apparatus, the points arranged so the apparatus is stable and can be transferred at high robotic speeds.

22. The apparatus of claim 1 wherein the rods are removable from the frame.

23. The apparatus of claim 22 wherein the rods comprise a means for locking and unlocking the rods to the frame.

24. The apparatus of claim 1 wherein the rods and frame are designed to minimize shadowing effects on reticles supported in the apparatus and being exposed to megasonic energy.

25. The apparatus of claim 1 wherein the frame comprises means to facilitate proper alignment of the apparatus in a process tank.

26. The apparatus of claim 1 wherein the rods comprise a first bottom holding rod and second bottom holding rod, the first bottom holding rod connected to the frame at a lower position than the second bottom holding rod so that when a reticle is loaded into the apparatus, a top edge of the reticle is at an incline.

27. A method of processing reticles comprising:
providing an apparatus comprising a structural frame carrying at least three holding rods, the rods constructed of a hard inner core material and a chemically resistant outer material;
loading at least one reticle into the apparatus;
positioning the apparatus and loaded reticles in a process chamber; and
performing a first reticle treatment process to the loaded reticles.

28. The method of claim 27 further comprising performing a second reticle treatment process to the loaded reticles without removing the reticles from the apparatus.
